(19) United States
(12) Patent Application Publication
(10) Pub. No.: US 2005/0166047 A1
(43) Pub. Date: Jul. 28, 2005

(54) Intra-encapsulation intelligent searching of an object

(76) Inventor: Wayne J. Tollett, Spicewood, TX (US)

Correspondence Address: ZAGORIN O'BRIEN GRAHAM LLP, 7600B N. CAPITAL OF TEXAS HWY., SUITE 350, AUSTIN, TX, 78731, US

(21) Appl. No.: 10/764,326

(22) Filed: Jan. 23, 2004

(51) Int. Cl. H04L 9/00

(52) U.S. Cl. 713/167

(57) ABSTRACT

A functional encoding is operable to perform intelligent searching of an encapsulated object (e.g., a select object, an input object, a table object, a graphic object, etc.) with an accumulated sequence of input elements. The functional encoding accumulates the sequence of input elements and searches the encapsulated object for a member that includes the sequence of input elements. If a keystroke delay time period expires, then the accumulated sequence of input elements is discarded for the next sequence of input elements.

### REFERENCE TO COMPUTER PROGRAM LISTING APPENDIX

A Computer Program Listing Appendix is filed herewith on compact disk, the material of which is hereby incorporated by reference in its entirety. The compact disk is submitted in duplicate (labeled COPY 1 and COPY 2) and each of the two identical disks contains the following three files: “sequencesearch.txt” having a file size of 9,704 bytes (10 kb) with a file creation date of Jan. 22, 2004; “tablesequencesearch.txt” having a file size of 5,873 bytes (6 kb) with a file creation date of Jan. 22, 2004; and “multiobjectsequencesearch.txt” having a file size of 11,714 bytes (12 kb) with a file creation date of Jan. 22, 2004.

### COPYRIGHT NOTICE

A portion of the disclosure of this patent document, including certain figures and the Computer Program Listing Appendix, contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND

1. Field of the Invention

The present invention relates to the field of computers. More specifically, the present invention relates to navigation of encapsulated objects.

2. Description of the Related Art

Conventional web pages encapsulate a myriad of objects including text boxes, list boxes, drop-down menus, image maps, tables, etc. These objects handle input and/or present data in accordance with a specification, such as a mark-up language. Web pages are further enhanced with controls, applets, plug-ins, and/or vector graphic animation.

Despite the emergence of this myriad of enhancements for web pages, objects lack the functionality to search object members with an accumulated sequence of input elements. Objects, such as list boxes and drop down menus, effectively use each input element as an index. As each character is entered, a list box locates a member of the list box that begins with the entered character. For example, if a user wants to select “United States” from a list box of countries, then the user cannot enter “un” because the list box will jump to the first list member that begins with the character ‘n’. Accordingly, a technique is desired that provides intelligent searching of objects.

### SUMMARY OF THE INVENTION

Intelligent searching of an encapsulated object facilitates intuitive navigation of an encapsulated object. In addition, intelligent searching within an encapsulation provides more efficient navigation of an encapsulated object as the number of object members increases. An encapsulated object accumulates a sequence of input elements. The encapsulated object searches its members to determine if one of the members includes the sequence of input elements. To enhance object navigation, one or more dimensions of an encapsulated object can be modified to allow visibility of members with at least one dimension that is not accommodated by the encapsulated object's initial dimensions. In addition, an object within an encapsulation can accumulate a sequence of input elements and locate in a target object within the encapsulation a member that includes the sequence of elements.

These and other aspects of the described invention will be better described with reference to the Description of the Preferred Embodiment(s) and accompanying Figures.

### BRIEF DESCRIPTION OF THE DRAWINGS

The present invention may be better understood, and its numerous objects, features, and advantages made apparent to those skilled in the art by referencing the accompanying drawings.

FIGS. 1A-1C depict part of a screenshot of an exemplary object of a web page being searched with accumulated input. Input can be accumulated in a variety of objects (e.g., select objects, input objects, graphic objects, etc.). FIG. 1A depicts an object 101, which is a drop-down menu of a web page 103. FIG. 1B depicts the object 101 with several object members visible to a user. FIG. 1C depicts the object 101 after a member has been selected and the drop-down menu closed. FIGS. 1A-1C also depict exemplary expansion and reduction of the object 101.

FIG. 2 depicts an exemplary flowchart for searching an object with accumulated input.

FIGS. 3A-3D depict exemplary expansion and reduction of a list box type object. FIG. 3A illustrates an inactive list box type object 301 of countries having an initial width. FIG. 3B illustrates an active list box type object 301 of countries having an expanding width. FIG. 3C illustrates the active list box type object 301 with expanded width. FIG. 3D illustrates the list box type object 301 after reduction.

FIG. 4 depicts an exemplary flowchart for manipulating width of an object.

FIGS. 5A-5B depict inter-object searching with accumulated input between exemplary objects. FIG. 5A depicts exemplary related objects. FIG. 5B depicts exemplary input accumulation at an object and searching of a target object.

FIG. 6 depicts an exemplary flowchart for inter-object searching with accumulated input.

FIG. 7 depicts an exemplary computer system according to some realizations of the invention.

The use of the same reference symbols in different drawings indicates similar or identical items.

### DESCRIPTION OF THE PREFERRED REALIZATION(S)

The description that follows includes exemplary systems, methods, techniques, instruction sequences and computer program products that embody techniques of the present invention. For instance, objects are described as being encoded according to a mark-up language, such as hypertext mark-up language (HTML), extensible mark-up language (XML), dynamic HTML, server-parsed HTML, standard generalized mark-up language, etc. However, it is understood that the described invention may be practiced without these specific details. In other instances, well-known protocols, structures and techniques have not been shown in detail in order not to obscure the invention.

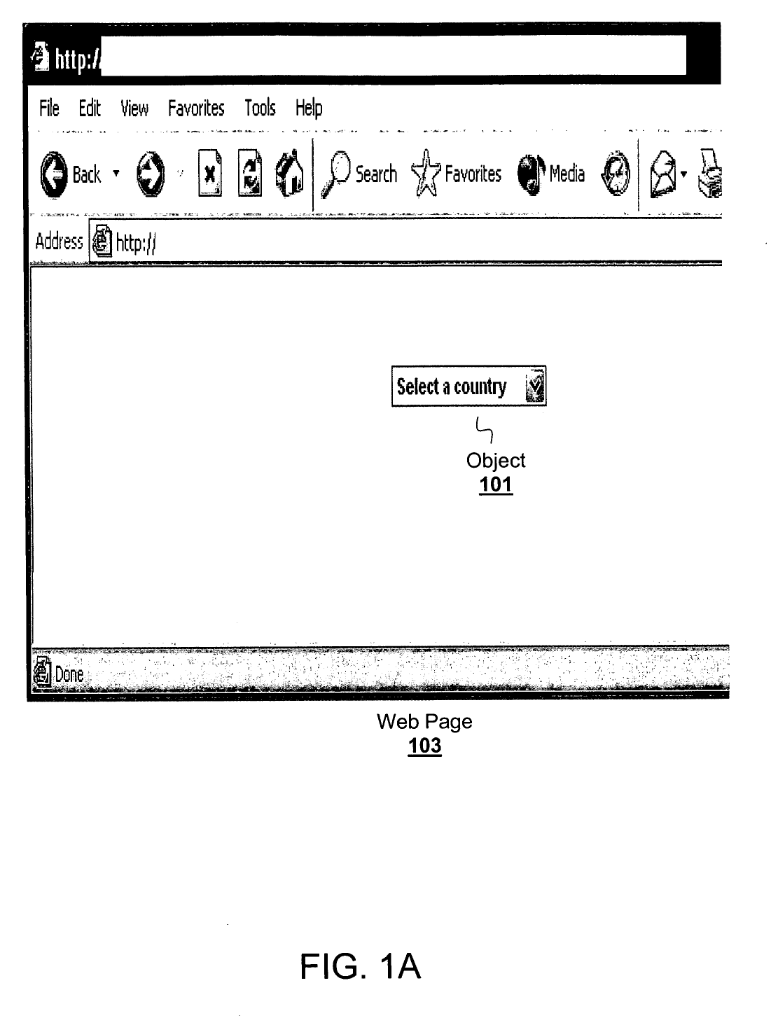

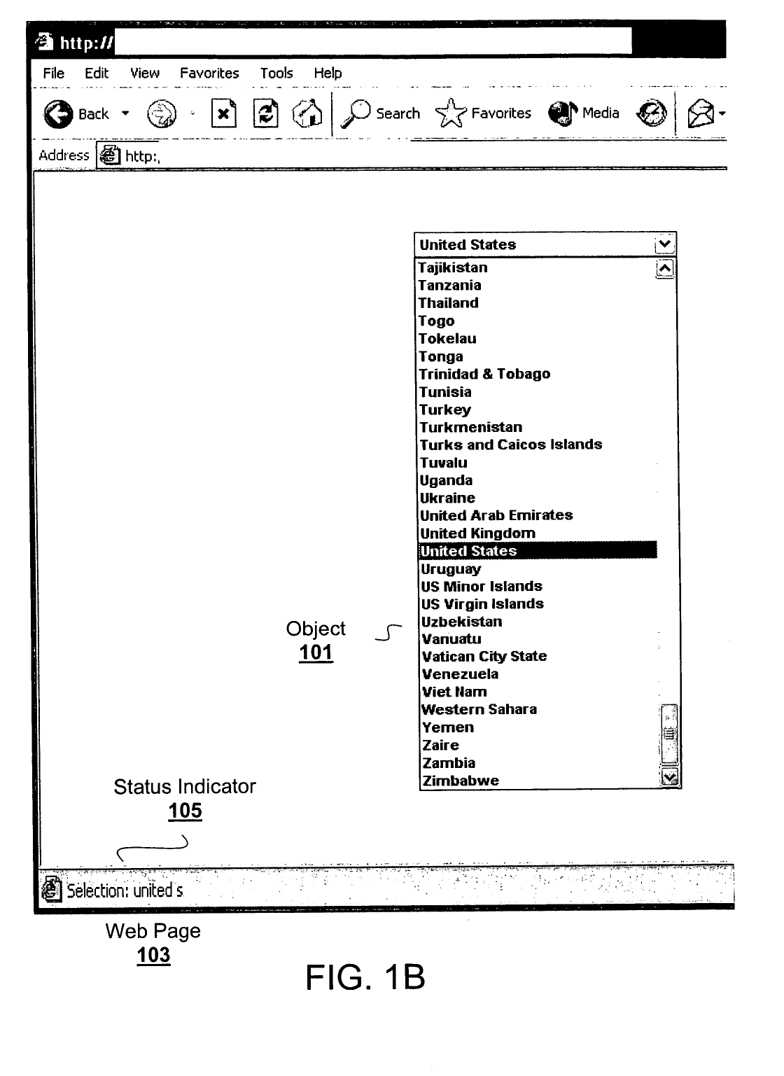

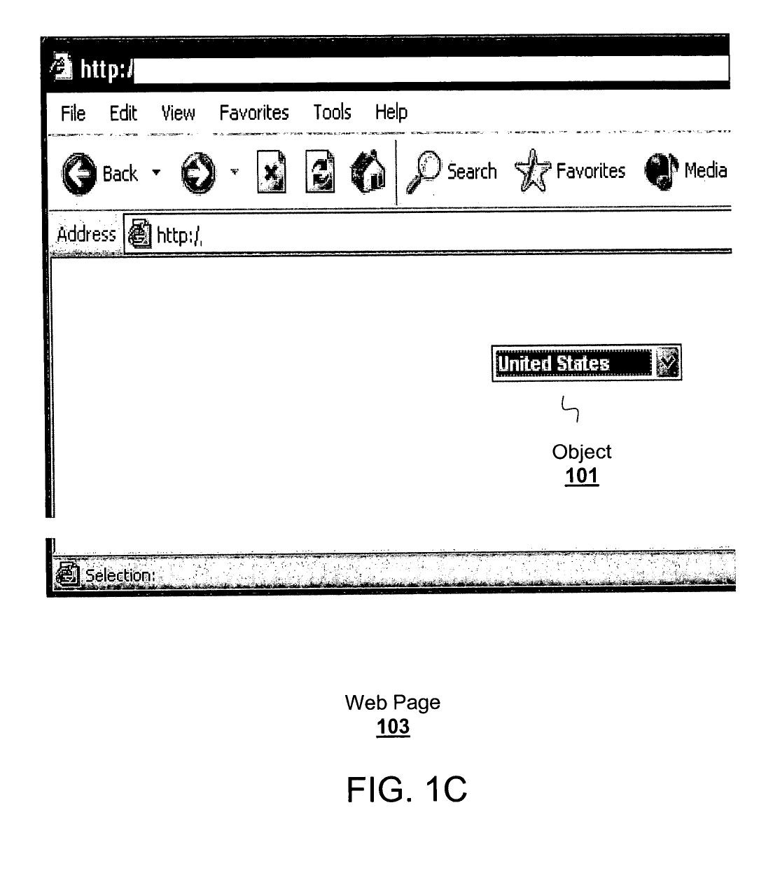

FIGS. 1A-1C depict part of a screenshot of an exemplary object of a web page being searched with accumulated input. FIG. 1A depicts an object 101, which is a drop-down menu of a web page 103. The web page 103 is an exemplary encapsulation of the object 101. The object 101 includes members, which are country names. FIG. 1B depicts the object 101 with several object members visible to a user. A status indicator 105 at the bottom of the web page 103 indicates that “united s” has been input. The object 101 has searched the object 101 for a member that includes the input. The member “United States” is highlighted in the object 101. The object 101 skips over the members “United Arab Emirates” and “United Kingdom” after the 's' is entered. FIG. 1C depicts the object 101 after a member has been selected and the drop-down menu closed. The object 101 displays the member “United States” as the selected member. FIGS. 1A-1C also depict exemplary expansion and reduction of the object 101. The expansion and reduction of objects will be described in more detail later herein.

Searching within an encapsulation an encapsulated object for accumulated input facilitates more efficient selection of object members and goes beyond the limitation of searching objects based upon a single character or element. Instead of repeatedly entering the character ‘u’ to scroll through all of the members that begin with the character ‘u’, a user enters a portion of the characters of a desired object member and the object locates that desired member. An encapsulated object that included numerous object members beginning with the same element could easily be navigated with intelligent searching of the object members with more than a single element.

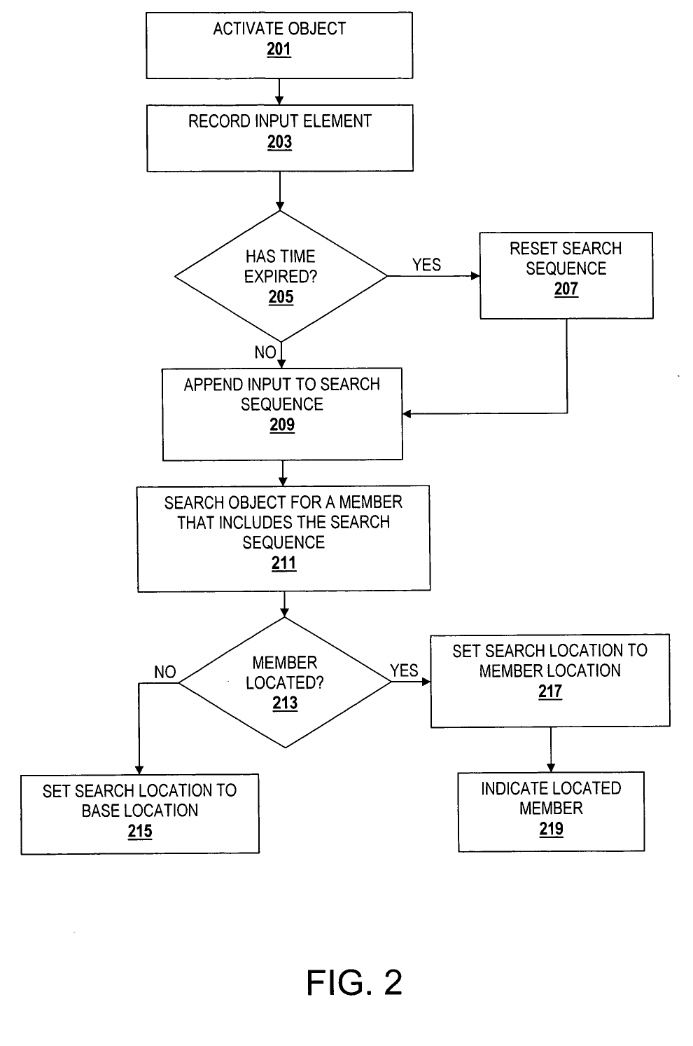

FIG. 2 depicts an exemplary flowchart for searching an object with accumulated input. At block 201, an object is activated. For example, focus of the web page 103 is set on the object 101 with a keystroke or pointing device. At block 203, an input element is recorded. For example, the first character ‘u’ is entered for the object 101 and stored. An input element may include an alphanumeric character, a symbol character, an image, biometric data, a hashed value, etc. At block 205, it is determined if a time period has expired. If the time period has expired, then control flows to block 207. If the time period has not expired, then control flows to block 209.

At block 207, a search sequence is reset. For example, if a user enters the characters “unit” and the user takes longer than the time period to enter the character ‘e’, then the search sequence is reset and the object 101 will search for a member that begins with the input character ‘e’. Various realizations of the invention may also reset the search sequence if a special character is entered (e.g., delete, backspace, etc.). Control flows from block 207 to block 209.

At block 209, the input element is appended to the search sequence. At block 211, the object is searched for a member that includes the search sequence. At block 213, it is determined if a member has been located. If a member that includes the search sequence has been located, then control flows to block 217. If a member that includes the search sequence has not been located, then control flows to block 215.

At block 215, the search location is set to a base location of the object. For example, the search location, which is the starting point for a search, is reset to the first member of the object 101, “Afghanistan.” Various realizations of the invention handle search misses differently and may maintain indication of a member with a search sequence match instead of the first member of the object upon a subsequent search sequence with a miss. For example, assume an object includes a list of cities within Texas and a user intends to select “Austin.” The user enters ‘a’, and the first city that includes an ‘a’ is indicated. The user enters “u” within the time period for keystroke delay, and the first city in Texas that begins with “au” (Austin) is indicated. The user erroneously enters ‘z’ within the time period for keystroke delay, and a city that begins with “auz” cannot be found, but “Austin” is still indicated. After the keystroke delay time period expires, the next search sequence will begin from “Austin,” instead of the beginning of the object.

At block 217, a search location is set to the located member's location. For example, the search location is set to the location of “United Arab Emirates.” After the next input element is received, searching will begin from “United Arab Emirates” instead of “Afghanistan.” At block 219, the located member is indicated. For example, the located member is highlighted. Although objects with text based members are described, an object may include multiple images, hashed value sequences, sequences of audio data, etc.

The following exemplary code includes functions for receiving input and searching an encapsulated object for the input. The exemplary code may be implemented with a scripting language, an interpreted language, a virtual machine language, etc.

function KeyPress( )
{
var SaveCurrentTimmer = CurrentTimmer;// Save old timer
CurrentTimmer = new Date( ); // Get new timer
TypeAheadActive = true;
if (!SaveCurrentTimmer)

SaveCurrentTimmer = CurrentTimmer;

var TimeDifference = CurrentTimmer.valueOf( ) −

SaveCurrentTimmer.valueOf( );

if (TimeDifference > keystrokedelay)

SaveTypeAhead = “”; // Reset Type Ahead String

// add input character to the SearchSelect string
SaveTypeAhead = SaveTypeAhead +

String.fromCharCode(event.keyCode);

if (SaveTypeAhead.length == 1)

SearchSelectList( SaveTypeAhead, 1);

else SearchSelectList( SaveTypeAhead, 0) // Step
event.returnValue = false;
}

The exemplary function KeyPress initiates a timer, which resets the search string SaveTypeAhead if delay between key strokes exceeds a given threshold. The threshold key delay for resetting the search string can vary to allow greater delay or less delay.

function SearchSelectList(str, baseindex)
{
var lengthofstring = str.length; // Length of search string
// Determine original position in object
var offsetindropdown = this.selectedIndex;
// Current position in object
var icnt = offsetindropdown + baseindex;
if (icnt >= this.options.length)

| | |
|---|---|
| icnt = 0; | // Start at base |

| | |
|---|---|
| if (StatusBarDisplay) | // Show Status Bar |

window.status = “Selection: ” + str;

str = str.toLowerCase( ); // Change string to lower case
do {

// Check if the current entry matches
if (str ==
this.options[icnt].innerText.substr(0,lengthofstring).toLowerCase( ))

| | |
|---|---|
| return SelectValue(icnt); | // Match |

| | |
|---|---|
| if (++icnt >= this.options.length) | // Check for End |

| | |
|---|---|
| icnt = 0; | // Try again |

| | |
|---|---|
| } while (icnt != offsetindropdown); | // Keep trying |

| | |
|---|---|
| return false; | // No match found |
| } | |

Additional factors to be taken into consideration for intelligent searching of an encapsulated object include offsets within the object, such as a hierarchy of object members. The exemplary function SearchSelectList is called from the function KeyPress. The function SearchSelectList receives a search string from the function KeyPress. The function SearchSelectList determines where the searching of the object should begin and then begins to search each object member from the determined starting point. SearchSelectList determines the length of the search string, and compares the search string with each object member up to the length of the search string (i.e., if the search string is 4 characters and an object member is 8 characters, then the search string will be compared to the first 4 characters of the object member). If a match is found, then an exemplary function SelectValue is called and the result of the called function is returned to KeyPress. If SearchSelectList arrives at the end of the object, then SearchSelectList continues to search for the object from the beginning of the object. If a match is not found and SearchSelectList arrives at the starting point of the search, then the object does not have an object member that includes the search string. The following exemplary function SelectValue, which is called by the function SearchSelectList, tracks the object index of an object member that includes the search string and sets the object to indicate the object member.

function SelectValue(CurrentIndex)
{
if (CurrentIndex >= 0 && CurrentIndex < this.options.length)
{

SaveIndex = CurrentIndex;
this.selectedIndex = CurrentIndex;

}
return true;
}

Various realizations of the invention apply intelligent searching functionality differently. A functional encoding that performs intelligent searching of an encapsulated object with an accumulated input sequence may be included in the encapsulation with the objection (e.g., as another object, in a header of the encapsulation, etc.). An encapsulation may include a reference to a functional encoding that performs intelligent searching when executed. The following is an exemplary header that includes a reference to an HTML component, which includes the above exemplary code or code similar to the above exemplary code.

<!DOCTYPE HTML PUBLIC “-//W3C//DTD HTML 4.0
Transitional//EN”>
<HTML>

<HEAD>

<title></title>

<meta name=“GENERATOR” content=“Microsoft Visual Studio .NET
7.1”>
<meta name=“CODE_LANGUAGE” content=“Visual Basic .NET 7.1”>

<meta name=“vs_defaultClientScript” content=“JavaScript”>

<meta name=“vs_targetSchema”
content=“http://schemas.microsoft.com/intellisense/ie5”>

<STYLE>

SELECT { BEHAVIOR: url(typeahead.htc) }

</STYLE>

</HEAD>

The above exemplary web page header refers to a location (url—uniform resource locator) of an HTML component typeahead.htc to define behavior of a select object. Of course, realizations of the invention are not limited to defining behavior of a select object, and define behavior of input objects, table objects, graphic objects, and/or other display or input type objects. As previously stated, the exemplary component typeahead.htc includes code the same as or similar to the above exemplary code. In the exemplary header, the component defines behavior of the SELECT object. Hence, these objects will behave or operate in accordance with the indicated component. The exemplary component may also include additional functionality, such as the following, to modify properties for control of data entry.

function PropertyChange( )
{
// Change properties since we are controlling data entry
if (event.propertyName == “selectedIndex”)

dataentrychange.fire(createEventObject( ));

}

Functionality or control provided by an encapsulation can be overridden, overloaded, and/or modified in accordance with a separate functional encoding, such as an HTML component. Although the exemplary code is encoded in accordance with Java, various realizations of the invention encode functionality in accordance with different languages (e.g., interpreted languages, scripting languages, virtual machine languages, etc.).

As previously mentioned, FIGS. 1A-1C also depict expansion and reduction of a drop down menu type object. In FIG. 1A, the object 101 is displayed with an initial or default width. The object 101 is displayed with the initial width prior to activation. In FIG. 1B, the object 101 has expanded in width, thus allowing visibility of members having a width greater than the initial width. The object 101 expands while active as illustrated in FIG. 1B. In FIG. 1C, after selection of an object member, the object 101 reduces to the initial width.

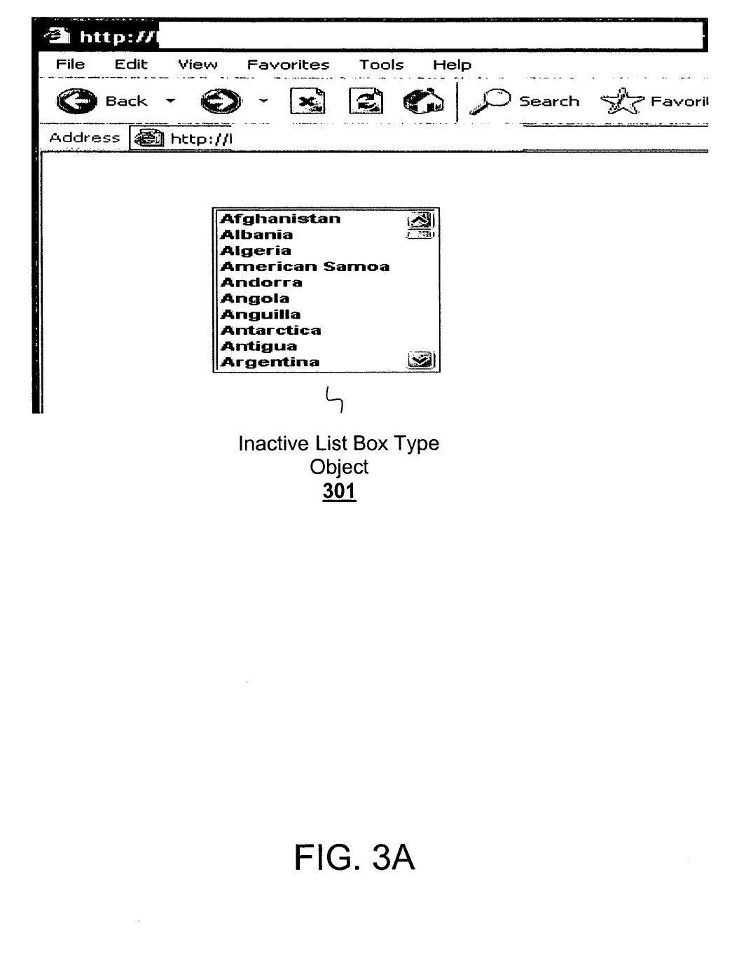

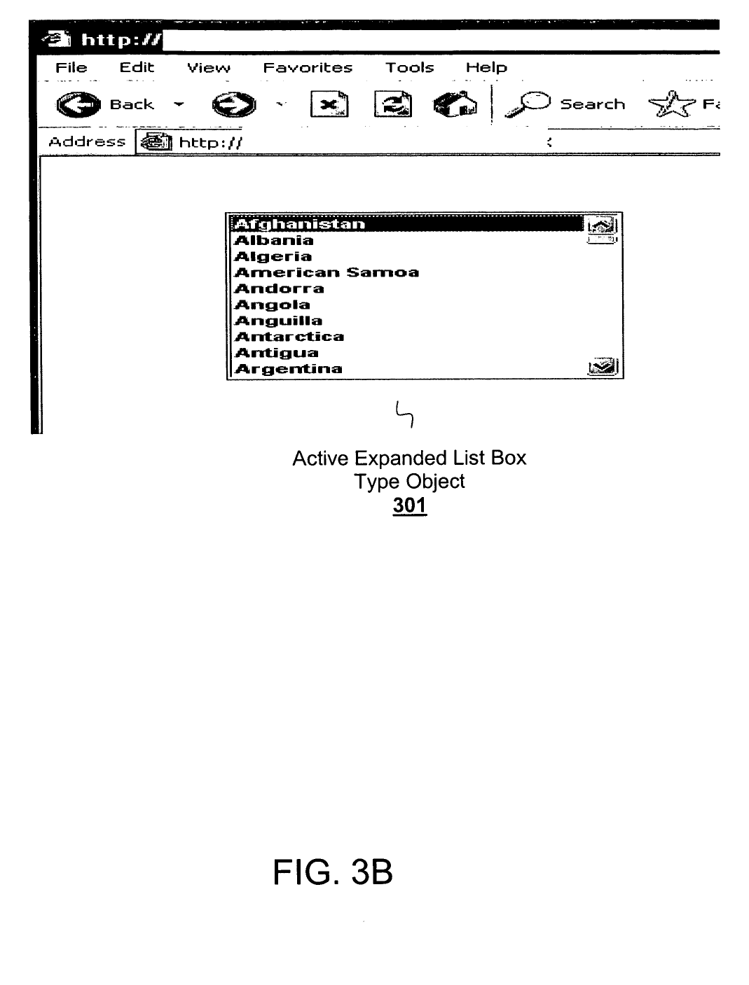

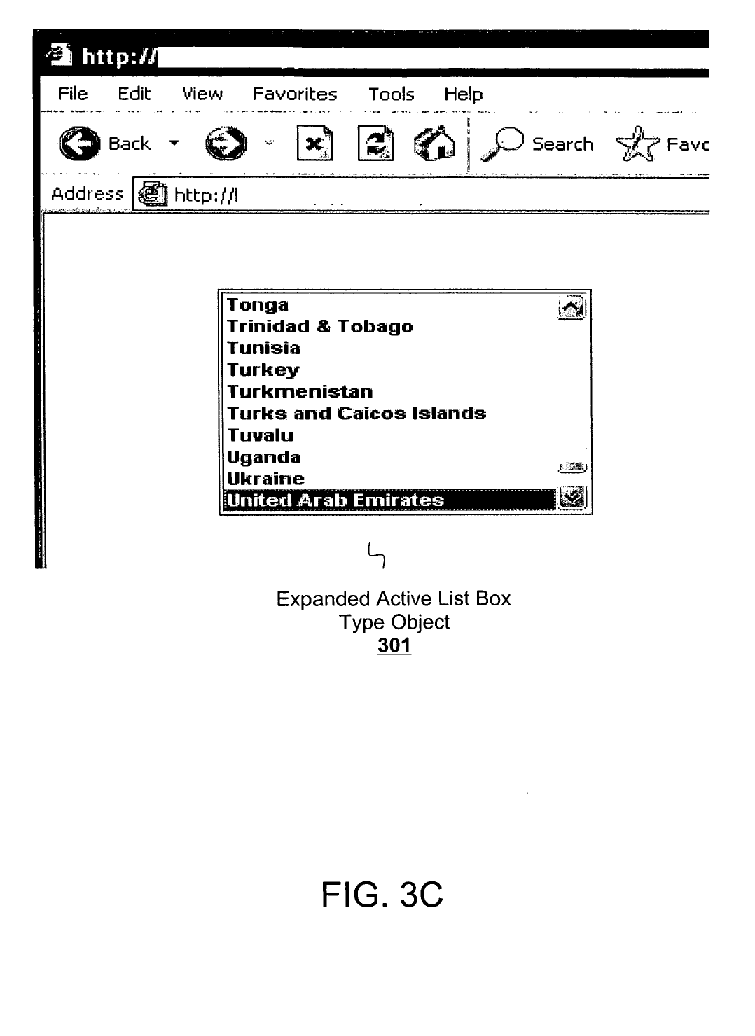

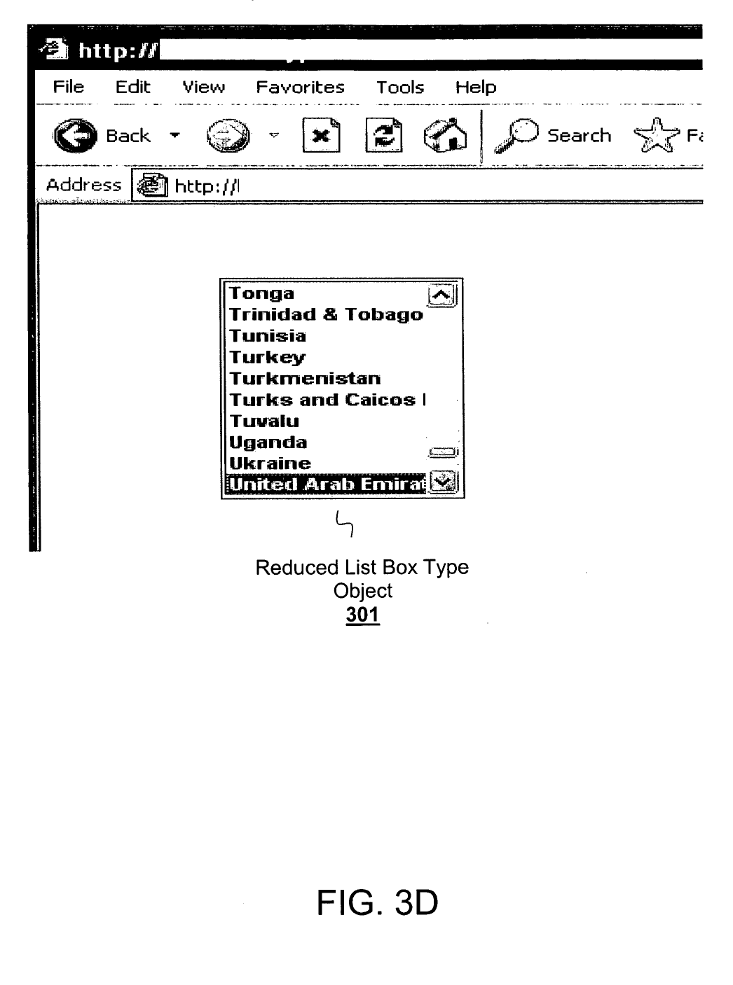

FIGS. 3A-3D depict exemplary expansion and reduction of a list box type object. FIG. 3A illustrates an inactive list box type object 301 of countries having an initial width. FIG. 3B illustrates an active list box type object 301 of countries having an expanded width. FIG. 3C illustrates the active list box type object 301 with expanded width. In FIG. 3C, the expanded width accommodates list members having widths greater than the initial width of the list box type object 301 during navigation or perusal of the list box object type 301. Expansion of the list box type object 301 can operate in conjunction with searching the list box type object 301 with accumulated input. Upon activation of the object 301, the width of the object 301 is expanded. While the object 301 searches for list members in accordance with accumulated input, the list members are visible in the expanded object 301. FIG. 3D illustrates the list box type object 301 after reduction. Upon an event, such as selection of a list member, change of focus, etc., the list box type object 301 is reduced to its initial width. Reduction of the object 301 to its initial width maintains integrity of the encapsulation (e.g., organizational integrity of multiple objects within an encapsulation).

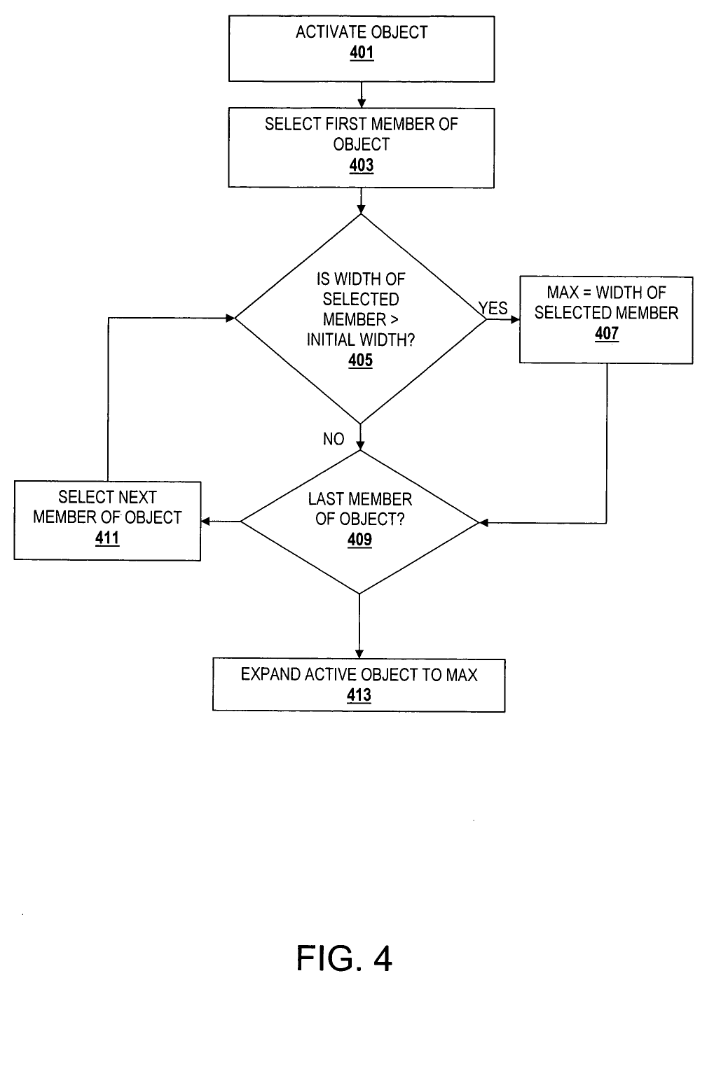

FIG. 4 depicts an exemplary flowchart for manipulating width of an object. At block 401, an object is activated. At block 403, a first member of the object is selected. At block 405, it is determined if the width of the selected member is greater than an initial width. If the width of the selected member is not greater than the initial width, then control flows to block 409. If the width of the selected member is greater than the initial width, then control flows to block 407.

At block 407, a maximum width is set to the width of the selected object member. Control flows from block 407 to block 409.

At block 409, it is determined if the selected member is the last object member. If the selected member is the last object member, then control flows to block 413. If the selected member is not the last object member, then control flows to block 411.

At block 411, the next object member is selected. Control flows from block 411 to block 405.

At block 413, the active object is expanded to the maximum width.

Although manipulation of an encapsulated object is described with reference to width, various realizations of the invention manipulate one or more other dimensions of an object. For example, an object that has images as members increases both height and width to accommodate the largest image, height of a vertical text list box is manipulated to accommodate a member with the most characters, etc. Furthermore, various criteria are considered to determine a greatest dimension. For example, if object members are text based, then criteria include one or more of number of characters, type of characters, font, style, and case.

The following is exemplary code for modifying width of an encapsulated object. The exemplary function setsize determines the length of each object member and records the greatest length. Additional exemplary code that factors in font and font size can be found preceding the claims.

| function setsize( ) | |
|---|---|
| { | |
| var icnt; | |
| icnt=0; | |
| var offsetindropdown = this.selectedIndex; | // Original |
| position in List | |
| var icnt = offsetindropdown + 0; | // first |
| position in List | |
| if (icnt >= this.options.length) | |

| | |
|---|---|
| icnt = 0; | // Try again |

do {

selectwidth = this.options[icnt].innerText.length;
if (selectmax <= selectwidth)

selectmax=selectwidth;

if (++icnt >= this.options.length) // Check for End

icnt = 0;

| | |
|---|---|
| } | while (icnt != offsetindropdown); |
| } | |

The function setsize is called by the following exemplary function OnFocus. The function OnFocus is triggered upon activation of an encapsulated object.

function OnFocus( )
{
selectmax=1;
selectmin=20;
selectwidth=this.style.width;
savewidth=this.style.width;
valzero=0;
this.selectedIndex=0;
// set index because the list box starts with −1
setsize( );
}

The exemplary function OnFocus may also perform various tasks for intelligent searching, such as determining keystrokedelay and initializing the timer. The exemplary code below may be added to OnFocus to complete such tasks.

if (keystrokedelay == null)

keystrokedelay = 1000; // Allow the programmer

to set the keystrokedelay but if it is not set default
StatusBarDisplay = true; // Always show Type Ahead in Status
Bar but allow programmer to modify
CurrentTimmer = new Date( ); // Initalize timer
SaveTypeAhead = “”; // Start at the first character
TypeAheadActive = false;

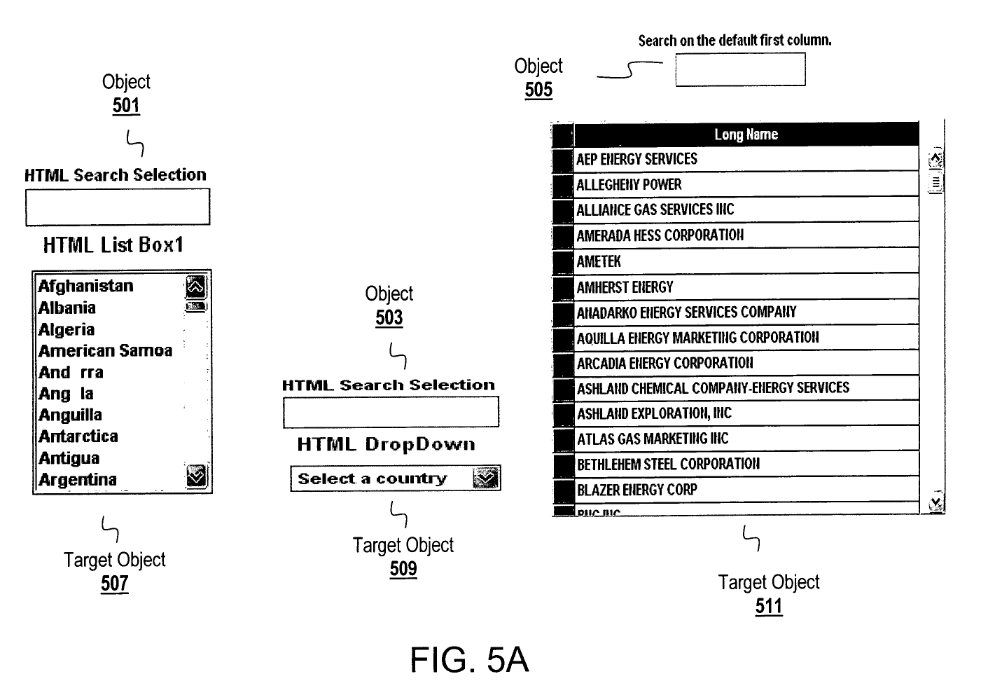

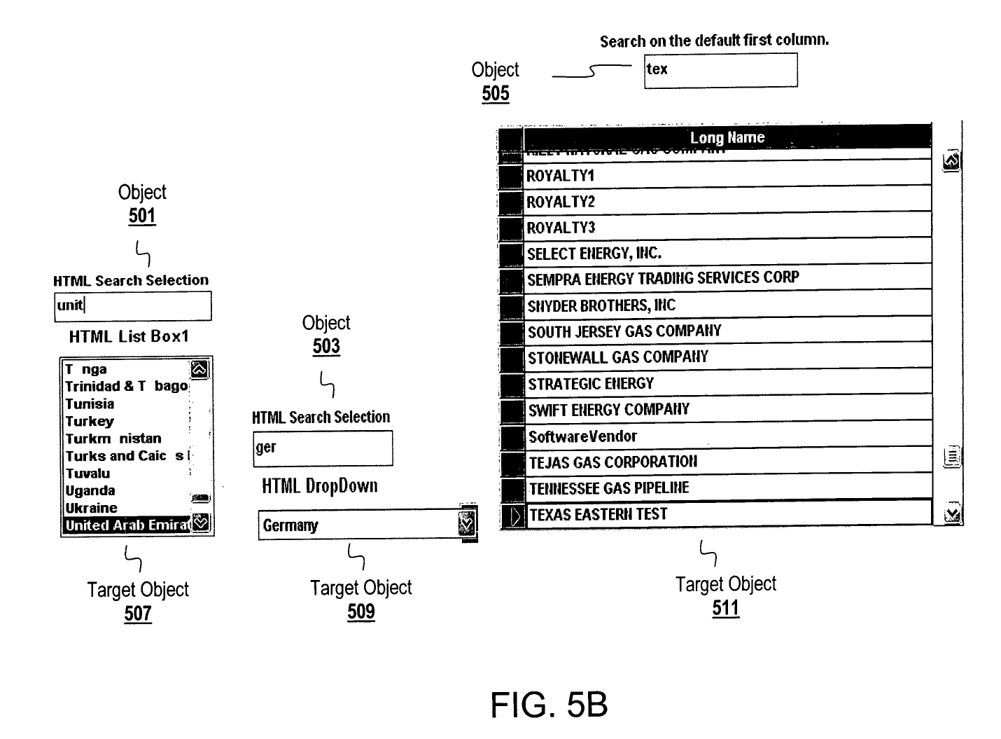

FIGS. 5A-5B depict inter-object searching with accumulated input between exemplary objects. FIG. 5A depicts exemplary related objects. A text box type object 501 is related to a target object 507, which is a list box of countries. A text box type object 503 is related to a target object 509, which is a drop-down menu of countries. A text box type object 505 is related to a target object 511, which is a grid object or table object of organizations. All of the objects may be encapsulated within the same web page, each instance of related objects may be encapsulated in different web pages, some of the objects 501, 503 and their target objects 507, 509 may be encapsulated in a web page separate from the object 505 and its target object 511, etc. Various realizations of the invention bind objects together differently (e.g., providing an object property that identifies a target object). For example, assume that the object 501 is identified as textbox1 and the target object is identified as listbox1 in the source of a web page that includes the objects 501 and 507 of FIG. 5. An exemplary source may include the following code:

<INPUT id=“textbox1” style=“Z-INDEX: 117; LEFT: 536px; WIDTH:
56px; POSITION: absolute; TOP: 8px; HEIGHT: 23px”
type=“hidden” size=“4” name=“textbox1”>
<SELECT style=“FONT-WEIGHT: bold; FONT-SIZE: 8pt; Z-INDEX:
105; LEFT: 28px; WIDTH: 125px; FONT-FAMILY: Arial; POSITION:
absolute; TOP: 156px; HEIGHT: 150px” accessKey=“listbox11”
size=“9” name=“listbox11”>

FIG. 5B depicts exemplary input accumulation at an object and searching of a target object. The object 501 has accumulated “unit” and located “United Arab Emirates” in its target object 507. The object 503 has accumulated “ger” and located “Germany” in its target object 509. The object 505 has accumulated “tex” and located “Texas Eastern Test” in its target object 511. Although the object 505 searches the first column of the target object 511 in FIG. 5B, the object 505 can search columns of the target object 511, search both columns and rows of the target object 511, etc. In FIG. 5B, a user activates an object and the active object operates on an inactive target object within the same web page. Thus, the object exercises control over the target object within the same encapsulation. The functionality of searching for accumulated input within an object and between objects is similar. Furthermore, inter-object control can be utilized for more than intelligent searching. For example, an activated object may cause its bound target object to expand. The exemplary code immediately preceding the claims includes exemplary code for expanding a target object (otherobject) from an object. The following exemplary OnFocus function calls a setsize object for a target object. An exemplary setsize function for bound objects can also be found immediately preceding the claims.

<PUBLIC:PROPERTY NAME=“otherobject” />
<!--Allow the programmer to change the selection of the other object
-->
function OnFocus( )
{
selectmax=1;
selectmin=20;
if (ontype == null)

{ontype=“none”;
otherobject=“none”;
}

if (otherobject == null)

otherobject=“none”;

if (otherobject != “none”)

```
{otherobjectid=window.document.getElementById(otherobject);
  savewidth=otherobjectid.style.width;
  if (selectwidth <= savewidth)
```

{savewidth=selectwidth;
otherobjectid.style.width=savewidth;}

```
  savewidth=otherobjectid.style.width;
  valzero=0;
  otherobjectid.selectedIndex=0; // set index because
```

the list box starts with −1

if (ontype == “select”)

setsize( );

}

}

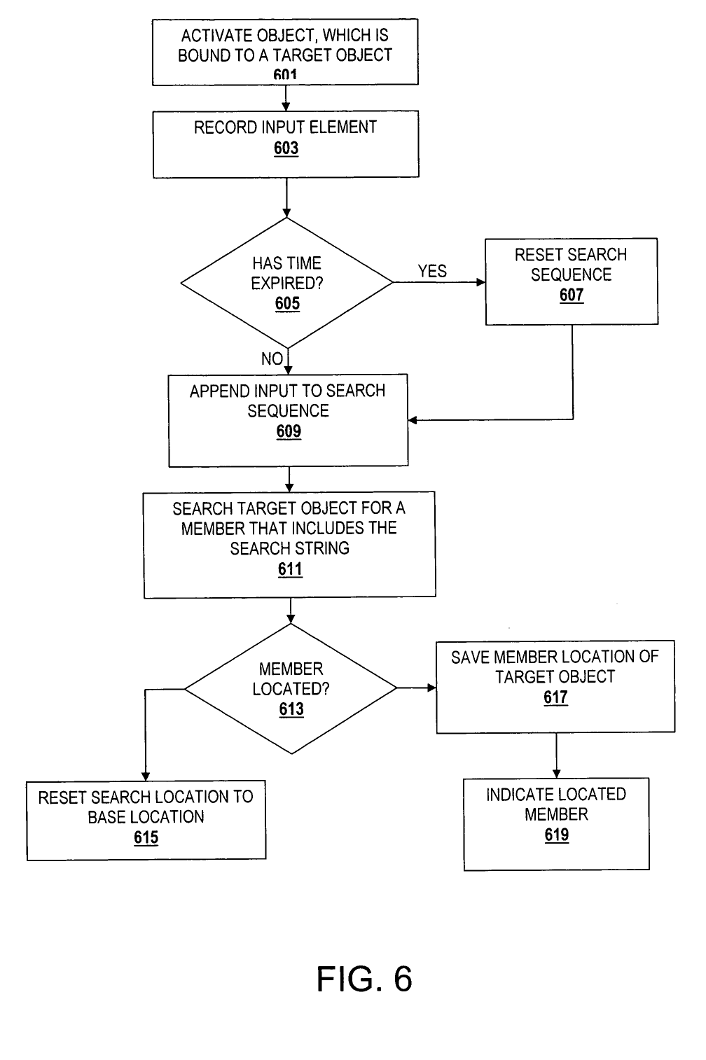

FIG. 6 depicts an exemplary flowchart for inter-object searching with accumulated input. At block 601, an object is activated. The object is bound to a target object. For example, an identifier of the target object is communicated to the object. At block 603, an input element is recorded. At block 605, it is determined if a time period has expired. If the time period has expired, then control flows to block 607. If the time period has not expired, then control flows to block 609.

At block 607, a search sequence is reset. Control flows from block 607 to block 609.

At block 609, the input element is appended to the search sequence. At block 611, the object is searched for a member that includes the search sequence. At block 613, it is determined if a member has been located. If a member that includes the search sequence has been located, then control flows to block 617. If a member that includes the search sequence has not been located, then control flows to block 615.

At block 615, the search location is set to a base location of the object.

At block 617, a search location is set to the located member's location. At block 619, the located member is indicated.

The following is exemplary code for intelligent searching of a target object with input accumulated in an object.

function SearchSelectList(str, baseindex)
{
var lengthofstring = str.length; // Length of search string
// Determine original position in object
var offsetindropdown = otherobjectid.selectedIndex;
// Current position in object
var icnt = offsetindropdown + baseindex;
if (icnt >= otherobjectid.options.length)

| | |
|---|---|
| icnt = 0; | // Start at base |

| | |
|---|---|
| if (StatusBarDisplay) | // Show Status Bar |

window.status = “Selection: ” + str;

str = str.toLowerCase( ); // Change string to lower case
do {

// Check if the current entry matches
if (str ==
otherobjectid.options[icnt].innerText.substr(0,lengthofstr
ing) .toLowerCase( ))

| | |
|---|---|
| return SelectValue(icnt); | // Match |

if (++icnt >= otherobjectid.options.length) // Check for

End

| | |
|---|---|
| icnt = 0; | // Try again |

| | |
|---|---|
| } while (icnt != offsetindropdown); | // Keep trying |

| | |
|---|---|
| return false; | // No match found |
| } | |

Although text based objects are illustrated, various realizations operate on objects that have as members images, biometric data, encrypted sequences, etc. For example, an object, such as a text box, is bound to an object that has images of state maps. The object searches the image object with text accumulated in the text box. In another example, an object is an image map. The image map is bound to a drop-down menu. As a cursor passes over the image map, the image map object searches the drop down menu in accordance with values related to image map coordinates. Hence, inter-object searching may or may not function in accordance with intelligent search.

Various realizations of the invention employ inter-object control differently. An object may interact with a hidden object that is bound to the object. For example, an object, upon activation, causes display of a hidden object that is bound to the object. The hidden object is searched for an input sequence accumulated at the activated object. The activated object drives searching for the input sequence in the hidden object. An indication of a member of the hidden object that includes the input sequence can be supplied to the object. Various realizations of the invention indicate the hidden object member from the hidden object, from the object, etc. Furthermore, various realizations of the invention handle the hidden object differently (e.g., reveal the hidden object while searching and conceal the hidden object after selection of a member, reveal the hidden object after indication of a member that includes the input sequence is supplied, maintain concealment of the hidden object and supply indications of hidden object members that include the input sequence to the object for display, etc.).

Moreover, interaction between objects is not limited to two objects. An object may interact with a target object and an object embedded within the target object. For example, an object (e.g., text box, list box, drop-down menu, etc.) controls searching of a display object (e.g., a list box, drop-down menu, etc.) that is embedded within another object (e.g., a table). The control object is bound to the target object. The control object determines an identifier of the target object and then determines the identifier of the embedded target object based at least in part on the target object's identifier. Once the object gains access to the embedded target object, the object can drive intelligent searching of the embedded target object.

While the flow diagram shows a particular order of operations performed by certain realizations of the invention, it should be understood that such order is exemplary (e.g., alternative realizations may perform the operations in a different order, combine certain operations, overlap certain operations, perform certain operations in parallel, etc.). For example, in FIG. 2, the search location may always return to the base location; the search location may not be set to the base location at block 215; block 219 may not be performed without additional input, such as a pointing device or special input (e.g., Enter); etc. In FIG. 4, width of all members may be determined in parallel; a greatest width of an object member may be predefined; etc.

The described invention may be provided as a computer program product, or software, that may include a machine-readable medium having stored thereon instructions, which may be used to program a computer system (or other electronic devices) to perform a process according to the present invention. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other types of medium suitable for storing electronic instructions.

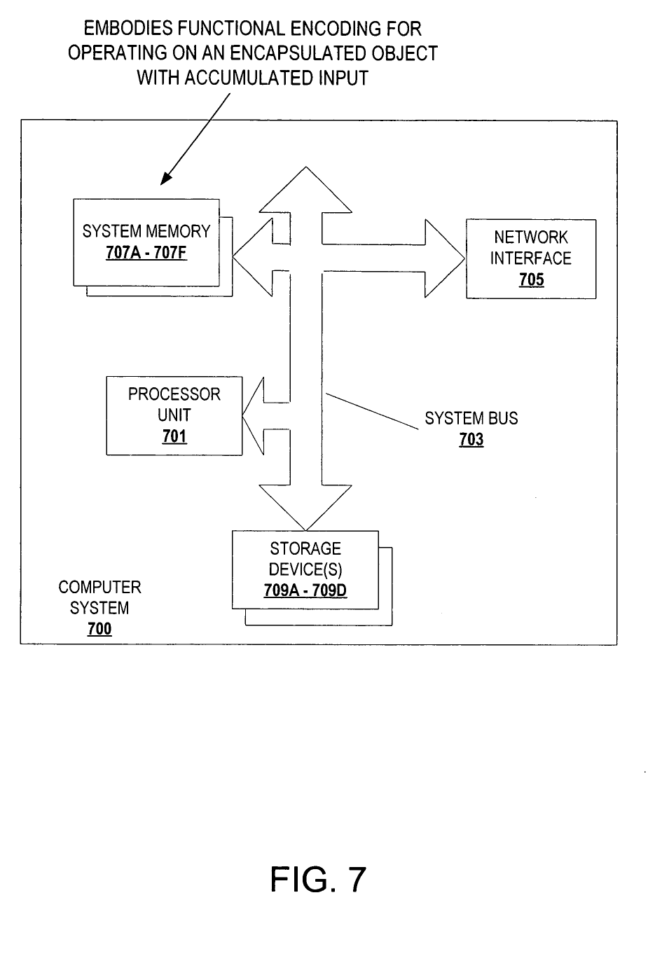

FIG. 7 depicts an exemplary computer system according to some realizations of the invention. A computer system 700 includes a processor unit 701 (possibly including multiple processors). The computer system 700 also includes memory 707A-707F (e.g., one or more of cache, SRAM DRAM, RDRAM, EDO RAM, DDR RAM, EEPROM, Flash memory, etc.), a system bus 703 (e.g., LDT, PCI, ISA, etc.), a network interface 705 (e.g., an ATM interface, an Ethernet interface, a Frame Relay interface, etc.), and a storage device(s) 709A-709D (e.g., optical storage, magnetic storage, etc.). Realizations of the invention may include fewer or additional components not illustrated in FIG. 7 (e.g., video cards, audio cards, additional network interfaces, peripheral devices, etc.). The processor unit 701, the storage device(s) 709A-709D, the network interface 705, and the system memory 707A-707F are coupled to the system bus 703. One or more of the system memory 707A-707F embodies functional encoding for operating on an encapsulated object (e.g., a module downloaded into memory over a network), such as searching for accumulated input or modifying one or more dimensions of an object, or one or more of the storage devices 709A-709D may host such a functional encoding (e.g., one or more modules downloaded to the storage devices 709A-709D via the network interface 705).

While the invention has been described with reference to various realizations, it will be understood that these realizations are illustrative and that the scope of the invention is not limited to them. Many variations, modifications, additions, and improvements are possible. More generally, realizations in accordance with the present invention have been described in the context of particular realizations. For example, modification of an encapsulated object's dimension is described with reference to width, but height may be modified in addition or instead of width (e.g., height of a vertical text box, dimensions of an object that includes images may be adjusted to allow visibility of the largest image, etc.). These realizations are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow. The following function determines a maximum width for an object.

function setsize( )
{
var icnt;
icnt=0;

| | |
|---|---|
| var offsetindropdown = this.selectedIndex; | // Original |
| position in List | |
| var icnt = offsetindropdown + 0; | // first |
| position in List | |

if (icnt >= this.options.length)

| | |
|---|---|
| icnt = 0; | //Try again |

do {

selectwidth = this.options[icnt].innerText.length;
if (selectmax <= selectwidth)

selectmax=selectwidth;

| | |
|---|---|
| if (++icnt >= this.options.length) | // Check for End |

icnt = 0;

} while (icnt != offsetindropdown);
var idofobject=this.id;
var st=this.style;
var str=st.cssText;
var set_font;
var test1=“font-size:”;
for(var i=0;i<str.length;i++) {

var icnt=i;
var tstr=str.substr(icnt,10).toLowerCase( );
if (tstr==test1)

```
{var icnt1=icnt;
  icnt1=icnt1+10;
  set_font=str.substr(icnt1,10);
}
```

}
var set_font_value;
var semi=“;“;
if (set_font!=null)

{for (var i=0;i<set_font.length;i++) {

var icnt=i;
var tstr1=set_font.substr(icnt,1).toLowerCase( );
if (tstr1==semi)

set_font_value=set_font.substr(0,icnt);

}

var new_value=set_font_value.substr(0,set_font_value.length -

2) .toLowerCase( );

if (new_value!=null)

{if (selectfontsize == null)

selectfontsize = new_value;

// Allow the programmer to set the font size but if it is not set
default

}

if (new_value==null)

(if (selectfontsize == null)

selectfontsize = 8;

// Allow the programmer to set the font size but if it is not set
default

}

}
if (selectfontsize == null)

| | |
|---|---|
| selectfontsize = 8; | // Allow the programmer to set |

the font size but if it is not set default
if (selectmax >= selectmin)

selectmax=selectmax * selectfontsize;

if (selectmax <= selectmin)

selectmax=selectmin * selectfontsize;

var set_left;
var test2=“left:”;
for(var i=0;i<str.length;i++) {

var icnt=i;
var tstr=str.substr(icnt,5).toLowerCase( );
if (tstr==test2)

(var icnt1=icnt;

icnt1=icnt1+5;
set_left=str.substr(icnt1,10);

}

}

var set_left_value;
if (set_left!=null)

(for(var i=0;i<set_left.length;i++) {

var icnt=i;
var tstr1=set_left.substr(icnt,1) .toLowerCase( );
if (tstr1==semi)

set_left_value=set_left.substr(0.icnt);

}

var new_value_left=set_left_value.substr(0.set_left_value.length

- 2) .toLowerCase( );
}
if (new_value_left!=null)

```
(var new_value_left1;
  new_value_left1 = screen.width-new_value_left;
  new_value_leftl= new_value_left1−selectmax;
  if (new_value_left1>0)
```

this.style.width=selectmax+“px”;

if (new_value_left1<=0)

{var width_test1=this.style.width;
selectmax=width_test1.substr(0,width_test1.length -

2) .toLowerCase( );

}

}
if (new_value_left==null)

(var width_test=this.style.width;

selectmax=width_test.substr(0,width_test.length -

2) .toLowerCase( );

}

}

The following function determines a maximum width of a target object.

function setsize( )
{(var icnt;
icnt=0;
var offsetindropdown = otherobjectid.selectedIndex;

| | |
|---|---|
| var icnt = offsetindropdown + 0; | // first position in List |
| if (icnt >= otherobjectid.options.length) | |

| | |
|---|---|
| icnt = 0; | // Try again |

| | |
|---|---|
| do | { |

selectwidth = otherobjectid.options [icnt].innerText.length;
if (selectmax <= selectwidth)

selectmax=selectwidth;

if (++icnt >= otherobjectid.options.length)

icnt = 0;

| | |
|---|---|
| } | while (icnt != offsetindropdown); |

var idofobject=otherobjectid.id;
var st=otherobjectid.style;
var str=st.cssText;
var set_font;
var test1=“font-size:”;
for (var i=0;i<str.length;i++) {

var icnt=i;
var tstr=str.substr(icnt,10) .toLowerCase( );
if (tstr==test1)

{var icnt1=icnt;
icnt1=icnt1+10;

set_font=str.substr(icnt1,10);
}

}

var set_font_value;
var semi=“;”;
if (set_font!=null)

{for(var i=0;i<set_font.length;i++){

var icnt=1;
var tstr1=set_font.substr(icnt,1) .toLowerCase( );
if (tstr1==semi)
set_font_value=set_font.substr(0,icnt); }

var new_value=set_font_value.substr(0,set_font_value.length -

2) .toLowerCase ( );

if (new value!=null)

{if (selectfontsize == null)

selectfontsize = new_value; }

if (new_value==null)

{if (selectfontsize == null)

selectfontsize = 8; }

}
if (selectfontsize == null)

| | |
|---|---|
| selectfontsize = 8; | // Allow the programmer to set |

the font size but if it is not set default
if (selectmax >= selectmin)

selectmax=selectmax * selectfontsize;

if (selectmax <= selectmin)

selectmax=selectmin * selectfontsize;
var set_left;

var test2=“left:”;
for(var i=0;i<str.length;i++) {

var icnt=i;

var tstr=str.substr(icnt,5) .toLowerCase( );

if (tstr==test2)

{var icnt1=icnt;
icnt1=icnt1+5;

set_left=str.substr(icnt1,10);
}

}

var set_left_value;
if (set_left!=null)

{for(var i=0;i<set_left.length;i++) {

var icnt=i;
var tstr1=set_left.substr(icnt,1) .toLowerCase( );
if (tstr1==semi)

set_left_value=set_left.substr(0,icnt);

}

var new_value_left=set_left_value.substr(0,set_left_value.length

- 2) .toLowerCase( );

}
if (new_value_left!=null)
{

var new_value_left1;
new_value_left1 = screen.width-new_value_left;
new_value_left1 = new_value_left1-selectmax;
if (new_value_left1>0)

otherobjectid.style.width=selectmax+“px”;

if (new value_left1<=0)

{var width_test1=otherobjectid.style.width;
selectmax=width_test1.substr (0,width_test1.length -

2) .toLowerCase ( );

}

}
if (new_value_left==null)

{var width_test=otherobjectid.style.width;
selectmax=width_test.substr(0,width_test.length -

2) .toLowerCase( );
}

1. A functional encoding for operating on one or more objects of an encapsulation provided over a network, the functional encoding comprising:
an input accumulation encoding operable to accumulate an input sequence; and
an input location encoding operable to determine if a member of an object includes the accumulated input sequence, wherein the input location encoding operates within the encapsulation; and
a selection encoding operable to supply an indication of a member of an object if the member includes an input sequence accumulated by the input accumulation encoding, wherein the functional encoding is in accordance with a specification for hyperobject presentation and hyperobject input handling.

2. The functional encoding of claim 1 wherein the specification includes an interpreted language, a scripting language, and a virtual machine language.

3. The functional encoding of claim 1, wherein the functional encoding is encoded integrally with the encapsulation.

4. The functional encoding of claim 1, wherein the web page control is encoded integrally with a template for the encapsulation.

5. The functional encoding of claim 4, wherein the encapsulation template includes cascading style sheets.

6. The functional encoding of claim 1 further comprising an expansion encoding operable to determine a greatest dimension of members of an object, to increase the object to at least the determined greatest dimension from an initial dimension.

7. The functional encoding of claim 6 wherein the expansion encoding reduces the object to the initial dimension upon a focus change event.

8. The functional encoding of claim 6 wherein the expansion encoding increases the object when the object is active and reduces the object when the object is no longer active.

9. The functional encoding of claim 6 wherein the expansion encoding determines the greatest dimension in accordance with at least one criteria that includes one or more of object member type, object member style, and number of object member elements.

10. The functional encoding of claim 9 wherein the member includes a character string and the criteria includes one or more of font, number of characters, style, case, and type of characters.

11. The functional encoding of claim 6 wherein the dimension includes one or more of height and width of the object.

12. The functional encoding of claim 6 further comprising the expansion encoding to determine a greatest second dimension and to increase the object to the greatest second dimension from an initial second dimension.

13. The functional encoding of claim 1 wherein the input is accumulated in a first object and the input location encoding operates on a second object.

14. The functional encoding of claim 13, wherein the second object is hidden.

15. The functional encoding of claim 14, wherein the hidden object is revealed while the first object is active.

16. The functional encoding of claim 13, wherein the second object is embedded within a third object, and the first object accesses the second object with an object indication based at least in part on the third object's indication, wherein the third object is bound to the first object.

17. The functional encoding of claim 13 wherein during input accumulation and input location, the first object is active and the second object is inactive.

18. The functional encoding of claim 13 wherein the object includes one or more of a select object, a table object, an input object, and a graphic object.

19. The functional encoding of claim 1, wherein the encapsulation is encoded in accordance with a hierarchically encoded mark-up language.

20. The functional encoding of claim 19, wherein the hierarchically encoded mark-up language includes one or more of hypertext markup language, standard generalized mark-up language, dynamic hypertext mark-up language, server-parsed hypertext mark-up language, and extensible mark-up language.

21. The functional encoding of claim 1, wherein the object includes one or more of a select object, a table object, an input object, and a graphic object.

22. The functional encoding of claim I further comprising the input accumulation encoding operable to discard the accumulated input upon expiration of a period of time.

23. The functional encoding of claim 1, wherein the accumulated input includes a sequence of symbols elected from an ordered set thereof.

24. The functional encoding of claim 23, wherein the symbols are encoded in accordance with one or more of ASCII encoding and Unicode encoding.

25. The functional encoding of claim 1 wherein the network includes one or more of an intranet and the Internet.

26. A web page control that, upon evaluation thereof, locates a web page object member that includes a user provided sequence, wherein the locating refines evaluation of the web page object against the user provided sequence as successive elements of the user provided sequence are accumulated, and that supplies indication of the object member that includes the user provided sequence.

27. The web page control of claim 26, wherein the web page control is instantiated in the web page as functionality of the object.

28. The web page control of claim 26, wherein the web page control is embodied, at least in part, as a functional sequence overloadable for corresponding functionality of the object.

29. The web page control of claim 26, wherein the web page control accumulates the user provided sequence in a second object, accesses the object, locates the object member with the user provided sequence accumulated in the second object, and supplies indication of the located object member.

30. The web page control of claim 29, wherein the object is a hidden object, which is revealed at least while the input object is active.

31. The web page control of claim 29, wherein the hidden object is embedded within a third object that is bound to the second object and the second object accesses the embedded object based at least in part on the third object's identifier.

32. The web page control of claim 26, wherein the web page includes an object property defined to comply with the web page control.

33. The web page of claim 26 encoded in accordance with a hierarchically encoded mark-up language.

34. The web page control of claim 33, wherein the hierarchically encoded mark-up language includes one or more of hypertext markup language, standard generalized markup language, extensible markup language, server-parsed HTML, and dynamic HTML.

35. The web page control of claim 26 encoded in accordance with one or more of an interpreted language, a scripting language, and a virtual machine language.

36. The web page control of claim 35 wherein the web page control is encoded integrally with the web page.

37. The web page control of claim 35, wherein the web page control is encoded integrally with a template for the web page.

38. The web page control of claim 37, wherein the web page template includes cascading style sheets.

39. The web page control of claim 26 wherein the user provided sequence includes a sequence of symbols elected from an ordered set thereof.

40. The web page control of claim 39, wherein the symbols are encoded in accordance with one or more of ASCII characters and Unicode characters.

41. The web page control of claim 26, wherein the object includes a select object, a table object, an input object, and a graphic object.

42. The web page control of claim 26, wherein the web page control expands at least one dimension of the web page object from an initial dimension to a maximum dimension to accommodate a largest object member.

43. The web page control of claim 42, wherein the web page control expands the object when focus is on the object and that reduces the object to the initial dimension upon an event.

44. The web page control of claim 43 wherein the event includes one or more of a pointing device selection of an object member, a key input selection of an object member, and a move focus event.

45. The web page control of claim 26, wherein the web page control accumulates the successive elements into the user provided sequence within a period of time, and accumulates a new user provided sequence if the time period expires.

46. A web page that searches an object with an input sequence of elements accumulated within a period of time and that selects an object member that includes the accumulated input sequence, wherein the web page encapsulates at least the object.

47. The web page of claim 46 that also determines a greatest dimension from the object members and that increases the object from an initial dimension to at least the greatest dimension, which allows presentation of one or more object members with the greatest dimension, when focus is on the object, and that reduces the object to the initial dimension upon a change event.

48. The web page of claim 47 wherein the change event includes one or more of a pointing device selection of an object member, a key input selection of an object member, and a move focus event.

49. The web page of claim 47 wherein the web page determines the greatest dimension with criteria including one or more of number of characters, font, case, style, and particular characters.

50. The web page of claim 46 wherein the input sequence is accumulated in an second object related to the object and the second object drives the search of the object with the accumulated input sequence.

51. The web page of claim 50 wherein the object includes a select object, input object, a table object, and a graphic object.

52. The web page of claim 46 wherein the web page discards the accumulated input sequence if the period of time expires.

53. The web page of claim 46 encoded in accordance with one or more of HTML, SHTML, SGML, XML, and DHTML.

54. The web page of claim 46 wherein the input sequence includes one or more of alphanumeric characters, symbols, and biometric data.

55. A method comprising:
recording a locally provided sequence of elements;
searching a remotely provided encapsulated object for an object member that includes the locally provided sequence of elements; and
supplying indication of the object member that includes the locally provided sequence of elements.

56. The method of claim 55 wherein the remotely provided encapsulated object has been provided over one or more of an intranet and the Internet.

57. The method of claim 55 wherein the sequence of elements is recorded within a period of time and discarded if the period of time expires.

58. The method of claim 55 wherein the sequence of elements is recorded from an second object, and the second object searches the encapsulated object, wherein the second object and the encapsulated object are within the same encapsulation.

59. The method of claim 58, wherein the encapsulated object is a hidden object.

60. The method of claim 59, wherein the hidden object is revealed while the second object is active.

61. The method of claim 58, wherein the encapsulated object is embedded within a third object.

62. The method of claim 58 wherein the encapsulation is encoded in accordance with a hierarchically encoded mark-up language.

63. The method of claim 62, wherein the hierarchically encoded mark-up language includes one or more of hypertext markup language, standard generalized markup language, extensible markup language, server-parsed HTML, and dynamic HTML.

64. The method of claim 62 wherein the second object includes one or more of an input object, select object, table object, and graphic object.

65. The method of claim 55 further comprising expanding the encapsulated object from an initial dimension to a maximum dimension that accommodates a largest object member.

66. The method of claim 65 further comprising reducing the encapsulated object from the maximum dimension to the initial dimension on a change event.

67. The method of claim 66 wherein the change event includes a pointing device selection of an object member, a key input selection of an object member, and a move focus event.

68. The method of claim 55 embodied as a computer program product encoded in one or more machine-readable media.

69. A method comprising:
defining an object property, which controls access and location of members of objects of an encapsulation, to accumulate in the encapsulation locally provided sequences, and to locate within the encapsulation an encapsulated object member that includes the locally provided sequence.

70. The method of claim 69, wherein an encapsulation is encoded in accordance with a hierarchically encoded mark-up language.

71. The method of claim 70, wherein the hierarchically encoded mark-up language includes one or more of hypertext markup language, standard generalized markup language, extensible markup language, server-parsed HTML, and dynamic HTML.

72. The method of claim 69 wherein the encapsulated objects include select objects, input objects, table objects, and graphic objects.

73. The method of claim 69 wherein the remotely provided encapsulated objects collectively provide one or more of content presentation, service provision, and an application.

74. The method of claim 72 wherein the remotely provided encapsulated objects are provided from one or more sources within a .Net framework.

75. The method of claim 69 further comprising defining the object property to increase at least one dimension of an encapsulated object from an initial dimension to a maximum dimension, wherein the maximum dimension is at least a largest object member's dimension.

76. The method of claim 75 wherein the object property further defines the behavior of an encapsulated object to reduce from the maximum dimension to the initial dimension upon a change event.

77. The method of claim 76 wherein the change events include one or more of a pointing device selection of an object member, a key input selection of an object member, and a move focus event.

78. The method of claim 69 wherein the object property definition refers to a component.

79. The method of claim 78 wherein the component encapsulates functionality to define object behavior.

80. The method of claim 79 wherein the component is encoded in accordance with an interpreted language, a scripting language, and a virtual machine language.

81. The method of claim 69 wherein a first object accumulates locally provided sequences and searches a second object.

82. The method of claim 69 embodied as a computer program product encoded in one or more machine-readable media.

83. A method comprising:
activating an encapsulated object that has been remotely provided;
expanding the encapsulated object from an initial dimension to a greater dimension, wherein the greater dimension accommodates a largest object member; and
reducing the encapsulated object to the initial dimension, wherein at least the encapsulated object is within an encapsulation.

84. The method of claim 83 further comprising determining the greater dimension in accordance with criteria that include one or more of object member element size, number of object member elements, type of object member element, and style of object member element.

85. The method of claim 83 wherein the encapsulation is encoded in accordance with a mark-up language.

86. The method of claim 83 wherein the encapsulated object reduces upon one or more of a pointing device selection of an object member, a key input selection of an object member, and a move focus event.

87. The method of claim 83 further comprising:
accumulating a locally provided input sequence with the encapsulation; and
searching the encapsulated object for an object member that includes the accumulated locally provided input sequence.

88. The method of claim 87 further comprising supplying an indication of an object member that includes the accumulated locally provided input sequence.

89. The method of claim 87 wherein the locally provided input sequence is discarded after a time period expires, and a new locally provided input sequence is accumulated within the time period.

90. The method of claim 87 wherein the input sequence is accumulated in a second object that is encapsulated within the encapsulation and the second object controls searching of the object.

91. The method of claim 83 embodied as a computer program product encoded in one or more machine-readable media.

92. A functional encoding for locally manipulating objects within an encapsulation, the functional encoding comprising:
a maximum dimension encoding operable to determine greatest dimension that accommodates a largest object member; and
a resize encoding operable to expand an encapsulated object from an initial dimension to a maximum dimension determined by the maximum dimension encoding and to reduce the encapsulated object to the initial dimension.

93. The functional encoding of claim 92, wherein the functional encoding is instantiated in the encapsulation as functionality of an encapsulated object.

94. The functional encoding of claim 92, wherein the functional encoding is embodied, at least in part, as a functional sequence overloadable for corresponding functionality of an encapsulated object.

95. The functional encoding of claim 92, wherein the encapsulation is encoded in accordance with a hierarchically encoded mark-up language.

96. The functional encoding of claim 95, wherein the hierarchically encoded mark-up language includes one or more of hypertext markup language, standard generalized markup language, extensible markup language, server-parsed HTML, and dynamic HTML.

97. The functional encoding of claim 92 wherein the functional encoding is encoded integrally with the encapsulation.

98. The functional encoding of claim 92, wherein the functional encoding is encoded integrally with a template for the encapsulation.

99. The web page control of claim 98, wherein the encapsulation template includes cascading style sheets.

100. The functional encoding of claim 92, wherein the greatest dimension includes one or more of a greatest width and a greatest height.

101. The functional encoding of claim 100, wherein the greatest dimension is determined with criteria that include one or more of style, case, font, and object member type.

102. The functional encoding of claim 92, wherein an encapsulated encoding is expanded upon activation of the encapsulated encoding and reduced upon a change event that includes one or more of a pointing device selection of an object member, a key input selection of an object member, and a move focus event.

103. The functional encoding of claim 92 further comprising:
an input accumulation encoding operable to accumulate locally provided input; and
a search encoding operable to search an encapsulated object with input accumulated by the input accumulation encoding.

104. The functional encoding of claim 103, wherein the input accumulation encoding accumulates input for a time period, and begins accumulating new input after the time period expires.

105. The functional encoding of claim 103, wherein the input accumulation encoding accumulates input at a second object, and the second object drives the search encoding on an encapsulated encoding bound to the second object, wherein the second object and the encapsulated object are within the same encapsulation.

106. The functional encoding of claim 105, wherein the encapsulation includes a web page.

107. An apparatus comprising:
a network interface; and
means for searching an encapsulated object from within the encapsulation with an input sequence for an object member that includes the input sequence.

108. The apparatus of claim 107 further comprising means for expanding the encapsulated object from an initial dimension to a maximum dimension.

109. The apparatus of claim 107 further comprising means for searching the encapsulated object from a second object within the same encapsulation, wherein the second object accumulates the input sequence.

110. An apparatus comprising:
a network interface; and
means for modifying at least one dimension of an encapsulated object within the encapsulation to accommodate a largest object member.

111. The apparatus of claim 110 wherein the means further comprise restoring the encapsulated object to maintain integrity of the encapsulation.

112. The apparatus of claim 110 further comprising means for accumulating an input sequence within a time period and searching the encapsulated object within the encapsulation for an object member that includes the input sequence.

113. The apparatus of claim 112 wherein the searching is driven from a second object that accumulates the input sequence, wherein the second object is bound to the encapsulated object and within the same encapsulation.

114. The apparatus of claim 110 further comprising means for controlling the encapsulated object from an input object within the encapsulation.
